(19) United States
(12) Patent Application Publication
(10) Pub. No.: US 2008/0248282 A1
(43) Pub. Date: Oct. 9, 2008

(54) METHOD FOR FIXING A POLYMER GEL COMPONENT

(75) Inventors: Jean-Luc MARTIN, Loriol sur Drome (FR); Jean-Claude MILLET, Etoile sur Rhone (FR)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: MILLET INNOVATION, Loriol sur Drome (FR)

(21) Appl. No.: 12/100,031

(22) Filed: Apr. 9, 2008

Related U.S. Application Data
(63) Continuation of application No. PCT/FR2006/002230, filed on Oct. 4, 2006.

(30) Foreign Application Priority Data
Oct. 12, 2005 (FR) 0510414

(51) Int. Cl. B32B 3/26; B29D 31/518

(52) U.S. Cl. 428/315.5; 156/60; 156/325; 156/214; 156/313

(57) ABSTRACT

A method is provided for fixing a silicone gel component, including a step of contacting the gel component with a sheet made of microporous material, such that the silicone gel is attracted upon contact with the sheet, thereby forming an assembly in which the component is fixed to the sheet without glue or adhesive. The method is applicable to the production of modules for protecting a human body part, in particular the foot.

### CROSS-REFERENCE TO RELATED APPLICATIONS

This application is a Continuation of International Application No. PCT/FR2006/002230, filed Oct. 4, 2006, which was published in the French language on Apr. 19, 2007, under International Publication No. WO 2007/042639 A2 and the disclosure of which is incorporated herein by reference.

### BACKGROUND OF THE INVENTION

The present invention concerns protecting a human body part, in particular the foot.

The foot has a shock absorbing layer called the footpad able to support up to eight times the weight of the body. The footpad also allows the mechanical “load” imposed by the weight of the body to be distributed. Various patients suffer from inflammation, callosities or pain, linked to inevitable wear of the natural footpad with age. Some people also suffer from foot abnormalities (callosities, corns, soft corns, hallux valgus) or cutaneous injuries (irritations, fissures, plantar warts, etc.). In addition, for some people, such as diabetics suffering from neuropathies or arteriopathies, it is absolutely vital to protect certain parts of the foot to avoid lesions from appearing.

Some polymer gels like polydimethylsiloxane oil (PDMS) silicone gels, such as those described in French Patent FR 2 712 487 or commercialized by Millet Innovation under the trademark Epithélium 26®, have viscoelastic features similar to human tissues. These materials are therefore particularly adapted to be used as protection modules to protect a human body part and in particular the foot. When they are used in the form of a cushion, these materials turn out to be efficient to relieve pains and protect all the painful areas of the foot.

Polymer gels are usually soft and stick more or less to the skin. Their implementation in the field of chiropody generally requires shaping the polymer gel by applying it onto the foot part to be protected. Then, so that it keeps its shape, the gel is fixed using a layer of glue on a piece of cloth, the polymer gel in conjunction with the piece of cloth constituting a protection module.

The implementation of such protection modules therefore entails to assembling several elements using glue, in the presence of the person for whom the protection module is intended.

The use of glue raises numerous difficulties. It entails, in particular, allowing a certain drying time in specific temperature conditions. In addition, contrary to silicone gels, glues are usually not neutral on a physiological level. The same is true for solvents which evaporate during the glue drying phase.

In addition, some protection modules in the form of cushions made of silicone gel are associated with a holding element to hold the cushion on the foot. The holding element has a curved semi-cylindrical shape to enter the interdigital space near the big toe and be held therein. To avoid any risk of lesion formation, the holding element is made of the same material as the cushion or a material having similar viscoelastic properties.

It is difficult to manufacture such a protection module. Indeed, it is not conceivable to make the protection module by molding in one part, because the shape of the holding element causes problems of draft. In addition, a silicone gel having the desired physical properties is not adapted to injection molding. The protection module must therefore be made in two different components, which must then be assembled, for example using glue or similar adhesive.

### BRIEF SUMMARY OF THE INVENTION

An aim of the present invention is to simplify assembling and/or keeping the shape of one or more components made of polymer gel. The present invention more particularly aims to suppress the use of glue.

These aims are achieved by taking advantage of a surprising effect, which occurs upon contacting some polymer gels with a sheet made of a microporous material.

More particularly, according to a first aspect, the invention provides a method for assembling a first material made of polymer gel with a second material. According to the invention, the second material is made of a microporous material. The method comprises contacting the first material with the second material without adding glue or other adhesive, the polymer gel linking both materials by penetrating micropores of the second material and creating a developed contact surface greater than the apparent contact surface between the two materials.

According to one embodiment, the second material comprises an agent able to fix to the polymer gel.

According to one embodiment, the agent able to fix to the polymer gel comprises silica particles.

According to one embodiment, the second material comprises a polyolefin.

According to one embodiment, the second material comprises polyethylene.

According to one embodiment, the polymer gel is a silicone gel.

According to one embodiment, the polymer gel comprises a polydimethylsiloxane obtained by mixing silicone oils.

According to one embodiment, the polymer gel is obtained from a partially polymerized mix of silicone oils.

According to one embodiment, the method comprises conforming the first material by applying the first material onto the body part to be protected, before contacting it with the second material.

According to one embodiment, the first material has the form of a cushion and the second material has the form of a sheet.

According to one embodiment, the second material is used to assemble between them two components formed of the first material, the polymer gel of the two components being attracted into the second material.

According to one embodiment, the method comprises conforming at least one of the components made of polymer gel, before contacting with the second material.

According to a second aspect, the invention also relates to an assembly of a first material made of polymer gel to a second material. According to the invention, the second material is made of a microporous material, the assembly being obtained by contacting the first material with the second material without adding glue or other adhesive, the polymer gel linking both materials by penetrating micropores of the second material and creating a developed contact surface greater than the apparent contact surface between the two materials.

According to one embodiment, the second material comprises an agent able to fix to the polymer gel.

According to one embodiment, the agent able to fix to the polymer gel comprises silica particles.

According to one embodiment, the second material comprises a polyolefin.

According to one embodiment, the second material comprises polyethylene.

According to one embodiment, the polymer gel is a silicone gel.

According to one embodiment, the polymer gel comprises a polydimethylsiloxane obtained by mixing silicone oils.

According to one embodiment, the polymer gel is obtained from a partially polymerized mix of silicone oils.

According to one embodiment, the second material is used to assemble between them two components formed in the first material, the polymer gel of the two components being attracted into the second material.

According to a third aspect, the invention also relates to a module for protecting a human body part, comprising an assembly as described above, the first material forming a cushion, and the second material having the form of a sheet.

According to one embodiment, the cushion is conformed by being applied onto the body part to be protected before being fixed to the microporous sheet to be maintained in shape.

According to one embodiment, the cushion has an opening, in order to form with the sheet a cavity susceptible of containing an active substance.

According to one embodiment, the module comprises a holding element formed in the first material, fixed without glue to another face of the microporous sheet, by penetration of the polymer gel into micropores of the sheet after contacting the holding element with the sheet.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a perspective view of a component made of polymer gel intended for the treatment of fissures on the heel, according to an embodiment of the invention;

FIG. 2 is a perspective view showing the implementation of the component shown in FIG. 1, according to an embodiment of the invention;

FIG. 3 is a perspective view of the component shown in FIGS. 1 and 2, assembled onto a support according to an embodiment of the method of the invention;

FIG. 4 is an exploded transverse sectional view of a protection module comprising different components made of polymer gel, assembled according to an embodiment of the method of the invention;

FIG. 5 is a perspective view of the assembled protection module shown in FIG. 4; and

FIG. 6 is a perspective view of a bandage made according to an embodiment of the method of the invention.

### DETAILED DESCRIPTION OF THE INVENTION

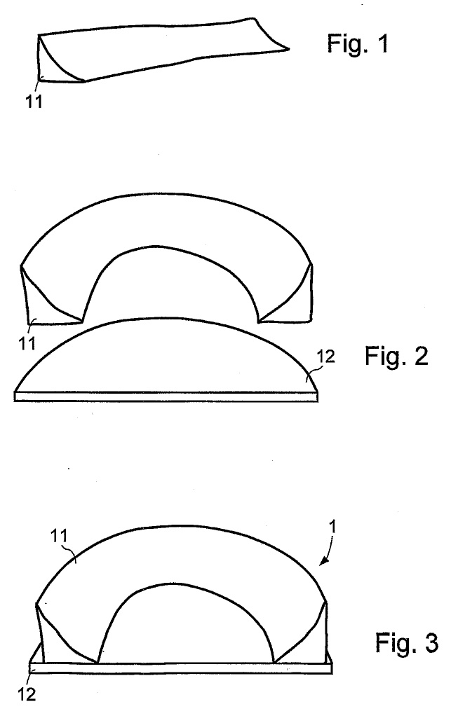

FIG. 1 shows a component 11 in the form of a small bar of substantially triangular cross-section, a face of which is concave in order to adapt to the external edge of a foot heel. The component 11 is made of a polymer gel, such as a silicone gel obtained by partial polymerization of a mix of silicone oils. This material advantageously has viscoelastic features similar to human tissues. The component 11 is, for example, made of a material comprising partially polymerized polydimethylsiloxane oils (PDMS), commercialized by Millet Innovation under the trademarks EPITHELIUM 26, EPITHELIUM 27 or EPITHELIUM 28.

The component 11 is preferably made in the form of a profile, whose section and dimensions are adapted to the part of the foot for which it is intended. In the example of FIG. 1, it is intended for being applied onto the rear edge of the heel part in contact with the floor, in standing position. The aim of the component 11 is particularly to protect this part of the foot in the event of deep heel fissures, or in case of particular weakness of the part, for example due to a post-surgical or, more usually, a post-traumatic situation.

In FIG. 2 the component 11 is curved to adapt to the outline of the heel part. Maintaining the shape of the component is performed according to the invention by a sheet 12 made of a microporous material on which the component 11 is applied. The sheet 12, for example, comprises a microporous material made of polyolefin, such as polyethylene or a mix of polyolefins, doped by silica powder, and optionally, carbon black. The size of the open cells of the microporous material is, for example, between 0.1 and 1 μm.

In FIG. 3 the component 11, curved in the manner shown in FIG. 2, is contacted with the sheet 12, the whole forming a protection module 1 according to the invention. Upon contact, the component 11 and the sheet 12 instantaneously stick to each other. This surprising effect can be explained by the microporous feature of the sheet 12 and by the fact that a part of the silicone oils constituting the component 11 are not completely polymerized and are therefore in the liquid state. Due to its porosity, the sheet 12 has microcavities or micropores on the surface, forming a developed total surface much greater than the apparent surface of the sheet. Upon contacting the sheet 12, the non-polymerized silicone oils of the component 11 are attracted by capillarity into the microcavities of the sheet surface. The result is that the developed contact surface between the component 11 and the sheet 12 is much greater than the apparent surface of the component contacting with the sheet. The mechanical link thus obtained between the component 11 and the sheet 12 turns out to be resistant, in particular, to shear and to a lesser extent to tear off, given the attraction of the terminations of silicon oils toward the silica particles which are the filler of the material 12. Assembling the component 11 and the sheet 12, therefore, does not require adding glue or other adhesive.

Advantageously, the sheet 12 comprises an agent able to fix to the polymer gel. The agent comprises, for example, silica particles. The proportion in volume of silica particles is, for example, between 35 and 80%. The diameter of the silica particles is, for example, between 0.01 and 20 μm. Such a sheet is, for example, commercial available under the trademark AEROSHOES®.

The free oils (not polymerized) turn out to have the property of being very attracted to silica. They are, therefore, immediately attracted into the sheet when contacting the sheet with the component 11. Bridges are then created within the microporous material between the terminations of PDMS molecules and silica. The bridges form very resistant mechanical links. The resistance of the fixation of the component on the sheet is consolidated by these bridges, which are very numerous, due to the great developed contact surface between the polymer gel and the sheet.

Assembling the protection module 1 may also be done easily by a chiropodist in the presence of the person for whom the protection module is intended. After fixing the component onto the sheet 12, the edges of the sheet which stick out from the component may be cut.

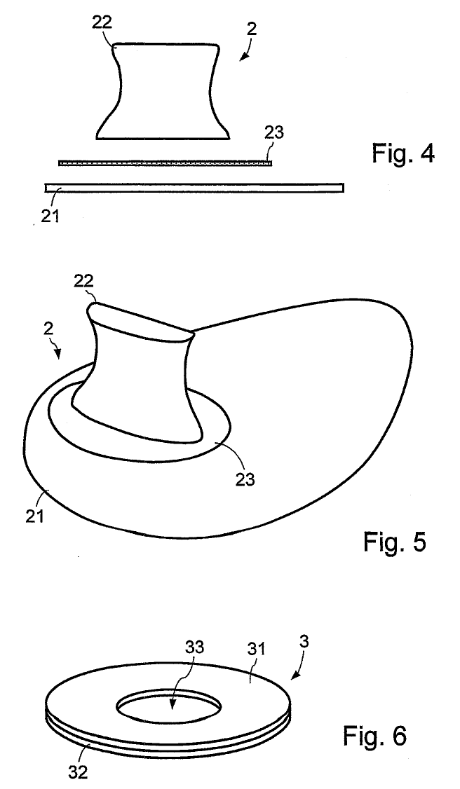

FIG. 4 shows a cushion 21 to be fixed onto a holding element 22 to make a protection module 2. The holding element has a curved, semi-cylindrical shape adapted to be located in the interdigital space near the big toe. The cushion and the holding element are made of a polymer gel.

According to the invention, a sheet 23 made of a microporous material is used to fix the holding element 22 on the cushion 21. As previously described with reference to FIGS. 2 and 3, simply contacting the sheet 23 with the polymer gel of the cushion and the holding element makes it possible to obtain a very strong mechanical link, without it being necessary to use glue or other adhesive. This method allows the protection module 2 shown in FIG. 5, comprising the holding element 22 fixed on a face of the cushion 21 by the sheet 23, to be obtained.

The chiropodist may, therefore, adapt the protection module to the person for whom it is intended, independently choosing a cushion and a holding element, adapted to the person's morphology. The two components are then assembled by applying a piece of microporous sheet onto the cushion substantially at the location of the holding element, and then assembling the holding element once the cushion has been placed onto the foot. In this manner, the position of the holding element on the cushion is adapted to the morphology of the person's foot. The components made of polymer gel may also be shaped on the foot before assembling.

The cushion and the holding element may be made of a material comprising partially polymerized polydimethylsiloxane oils. The microporous sheet may be made of polyolefin advantageously filled with silica.

FIG. 6 shows another application of the method according to the invention. The Figure shows a bandage 3 comprising a planar component 31 made of polymer gel and having a central opening 33. The component 31 is fixed to a microporous sheet 32, according to the method of the invention. The central opening 33 of the component 31 is thus closed on one side by the sheet 32, so as to form a cavity intended to receive a material (liquid, paste or gel) containing an active principle. Holding the bandage on the skin is, for example, performed by the intrinsic adhesive power of the polymer gel. Some silicone gels have such an adhesive power.

The materials described above may be used to make the component 31 of polymer gel and the microporous sheet 32.

In the applications previously described, liquids containing an active principle, such as antibacterials, antimycotic agents, deodorants, anti-inflammatory drugs, and the like, may be incorporated into the components made of polymer gel. It turns out that the presence of such liquids does not impact the solidity of the mechanical link with the microporous sheet.

It will appear clearly to those skilled in the art that the method according to the present invention is susceptible of various other embodiments and applications. Thus, the invention is not limited to the use of a polyolefin sheet filled with silica. It is, however, important that the polymer gel be capable of attraction by capillarity within the microporous material constituting the sheet. This last feature does not necessarily require that the polymer gel be a silicone gel, or that the polymer gel be obtained from a mix of partially polymerized polydimethylsiloxane oils.

It is not necessary either that the sheet comprise an agent, such as silica, able to fix to the polymer gel, since the mechanical link between the microporous sheet and a component made of polymer gel is obtained by the fact that the polymer gel penetrates into the sheet microporosities in order to obtain a developed contact surface much greater than the apparent contact surface between the sheet and the polymer gel, as explained above. In fact, the aim of providing such an agent in the microporous sheet is only to consolidate the solidity of the link.

The invention is not only applicable to the manufacture of foot protectors. It also applies to the manufacture of protectors of other body parts, all of these applications implementing the surprising property of these two materials spontaneously assembling upon contact.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A method for assembling a first material comprising a polymer gel to a second material comprising a microporous material, the method comprising: contacting the first material with the second material without adding glue or adhesive, such that the polymer gel links the first and second materials by the gel penetrating micropores of the second material and creating a developed contact surface greater than an apparent contact surface between the first and second materials.

2. The method according to claim 1, wherein the second material contains an agent able to fix to the polymer gel.

3. The method according to claim 2, wherein the agent able to fix to the polymer gel comprises silica particles.

4. The method according to claim 1, wherein the second material comprises a polyolefin.

5. The method according to claim 1, wherein the second material comprises polyethylene.

6. The method according to claim 1, wherein the polymer gel comprises a silicone gel.

7. The method according to claim 1, wherein the polymer gel comprises a polydimethylsiloxane obtained by mixing silicone oils.

8. The method according to claim 1, wherein the polymer gel is obtained from a partially polymerized mix of silicone oils.

9. The method according to claim 1, further comprising conforming the first material by applying the first material onto a body part to be protected, and thereafter contacting the first material with the second material.

10. The method according to claim 1, wherein the first material has a form of a cushion and the second material has a form of a sheet.

11. The method according to claim 1, wherein the second material is placed between two components of the first material, such that the polymer gel of the two components is attracted into the second material to assemble the components.

12. The method according to claim 11, further comprising conforming at least one of the components of polymer gel, before contacting the polymer gel with the second material.

13. An assembly of a first material comprising a polymer gel to a second material comprising a microporous material, the assembly comprising the first material being in contact with the second material without the presence of glue or adhesive therebetween, wherein the polymer gel links the first and second materials by penetrating micropores of the second material and creating a developed contact surface greater than an apparent contact surface between the first and second materials.

14. The assembly according to claim 13, wherein the second material comprises an agent able to fix to the polymer gel.

15. The assembly according to claim 14, wherein the agent able to fix to the polymer gel comprises silica particles.

16. The assembly according to claim 13, wherein the second material comprises a polyolefin.

17. The assembly according to claim 13, wherein the second material comprises polyethylene.

18. The assembly according to claim 13, wherein the polymer gel comprises a silicone gel.

19. The assembly according to claim 13, wherein the polymer gel comprises a polydimethylsiloxane obtained by mixing silicone oils.

20. The assembly according to claim 13, wherein the polymer gel is obtained from a partially polymerized mix of silicone oils.

21. The assembly according to claim 13, wherein the second material is located between two components of the first material, such that the polymer gel of the two components is attracted into the second material to assemble the components.

22. A module for protecting a human body part, the module comprising the assembly according to claim 13, wherein the first material has a form of a cushion, and the second material has a form of a sheet.

23. The module according to claim 22, wherein the cushion is conformed by application onto the body part to be protected before being assembled to the microporous sheet to be maintained in shape.

24. The module according to claim 22, wherein the cushion has an opening, so as to form with the sheet a cavity susceptible of containing an active substance.

25. The module according to claim 22, comprising a holding element formed of the first material, the holding element being fixed without glue or adhesive to a face of the microporous sheet opposite from the cushion, wherein the holding element is fixed by penetration of the polymer gel into micropores of the sheet upon contacting the holding element with the sheet.
